(19) United States
(12) Patent Application Publication
(10) Pub. No.: US 2024/0428087 A1
(43) Pub. Date: Dec. 26, 2024

(54) Enhanced System and Graphical User Interface Customization Based on Machine-Learned Context

(71) Applicant: Bank of America Corporation, Charlotte, NC (US)

(72) Inventors: Shola L. Oni, Atlanta, GA (US); Jo-Ann Taylor, Godalming (GB); Vijaya L. Vemireddy, Plano, TX (US); Jinna Kim, Charlotte, NC (US)

(21) Appl. No.: 18/213,402

(22) Filed: Jun. 23, 2023

(51) Int. Cl. G06N 5/022; G06Q 30/0601

(52) U.S. Cl. CPC G06N 5/022; G06Q 30/0641

(57) ABSTRACT

Arrangements for enhanced system and graphical user interface customization based on machine-learned context are provided. In some aspects, historical data may be received from a plurality of data sources and used to train a machine learning model to generate recommended modifications to systems or user interfaces based on user specific data. User specific data may be received from a plurality of data sources. The user specific data may be used as inputs to the machine learning model and, upon execution of the model, a recommendation for one or more modifications to at least one of a system or a user interface may be output. The recommendation may be provided to the user and, if accepted, an instruction causing the recommended modification may be generated and transmitted to one or more computing devices. Additional user specific data may be subsequently received and analyzed to identify additional modifications for recommendation and/or execution.

### BACKGROUND

Aspects of the disclosure relate to electrical computers, systems, and devices for providing enhanced system and graphical user interface modification and customization based on machine-learned context.

Providing accommodations for various users interacting with different computing devices can be a challenge for enterprise organizations. Often, it is difficult to ascertain the needs of a user and provide an accommodation in real-time. Further, conventional arrangements are often limited in a level of customization or modification available via different computing systems or devices. Accordingly, it may be advantageous to provide a system that relies on machine learning analysis of user specific contextual data to identify and implement modifications to one or more systems or user interfaces to accommodate a user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing user specific recommendations for enhanced customization of systems and user interfaces.

In some aspects, historical data may be received from a plurality of data sources (e.g., internal data sources, external data sources) and used to train a machine learning model to generate recommended modifications to systems or user interfaces based on user specific data. Accordingly, upon registering a user, user specific data may be received from a plurality of data sources. For instance, user specific data including internal data from an enterprise organization may be received, external data from public sources may be received, and the like. The user specific data may be used as inputs to the machine learning model and, upon execution of the model, the model may output a recommendation for one or more modifications to at least one of a system or a user interface.

In some examples, the recommendation may be provided to the user and, if accepted, an instruction causing the recommended modification may be generated and transmitted to one or more computing devices. Additional user specific data may be subsequently received and analyzed to identify additional modifications for recommendation and/or execution.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing enhanced system and graphical user interface customization based on machine-learned context in accordance with one or more aspects described herein;

FIGS. 2A-2I depict an illustrative event sequence for implementing enhanced system and graphical user interface customization based on machine-learned context in accordance with one or more aspects described herein;

FIG. 3 depicts an illustrative method for implementing enhanced system and graphical user interface customization based on machine-learned context in accordance with one or more aspects described herein;

FIGS. 4A-4D illustrate graphical user interfaces that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, users of various systems, applications, and the like, often have different needs to make their interaction a positive one. Conventional systems do not provide customized systems, functionality, user interfaces, and the like, that may improve the interactions with the user. Accordingly, aspects described herein rely on machine-learned contextual data to generate user specific, enhanced system and user interface customizations.

For instance, a machine learning model may be trained using historical data related to transactions, requested modifications, positive or negative feedback based on an interaction, public records data, social media data, and the like. Registered users may then receive user specific, recommendations for modifications to one or more systems or user interfaces, based on execution of the machine learning model using user specific data as inputs. If the user accepts the recommended modification, a computing platform may generate and transmit an instruction causing modification of a system or user interface to a computing device for execution.

In some examples, the modification may be to a display of a user interface or other presentation of data. For instance, a font size may be increased or decreased, a volume of audio output may be increased or decreased, a color may be changed, an arrangement of selectable options may be modified (e.g., size, position, or the like), and the like. In some examples, terminology associated with a user's hobbies or interests may be used in presenting data (e.g., musicians may make money via “gigs” rather than hours worked and data may be presented using terminology related to gigs to make the information more easily understood or accessible to the user).

In some arrangements, the modification may be to functionality of a system. For instance, one or more additional functions may be offered to a user, one or more functions may be indicated as unavailable for the user, or the like.

In some examples, the system may monitor user data to identify additional modifications for recommendations (e.g., modifications to already modified systems or user interfaces, modifications to other systems or user interfaces, or the like). Accordingly, as a user's contextual data changes (e.g., new interests, new spending habits, changes in life stage, or the like) the system may detect changes and recommend modifications to accommodate those changes.

These and various other arrangements will be discussed more fully below.

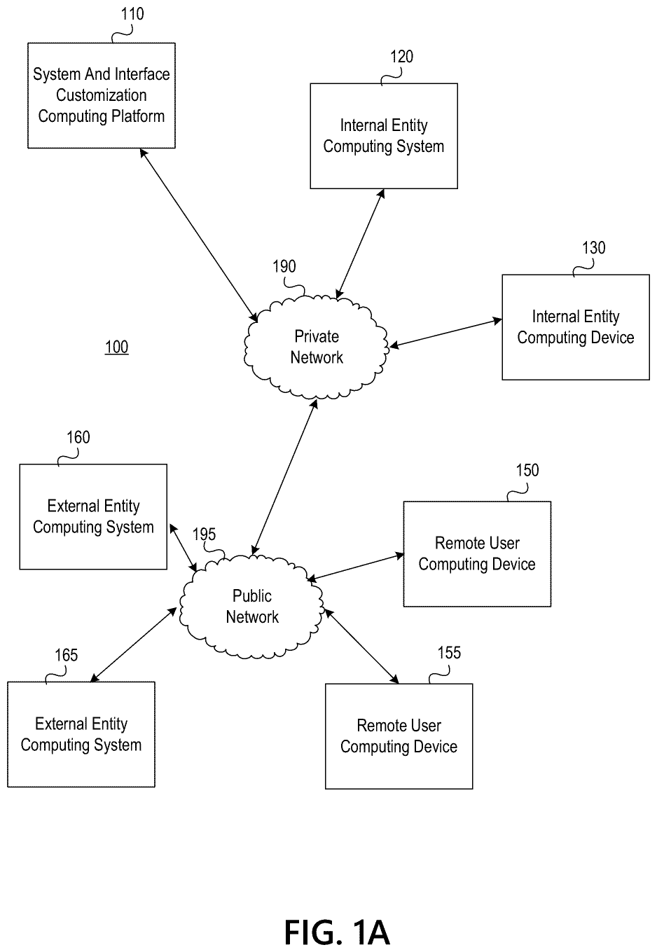

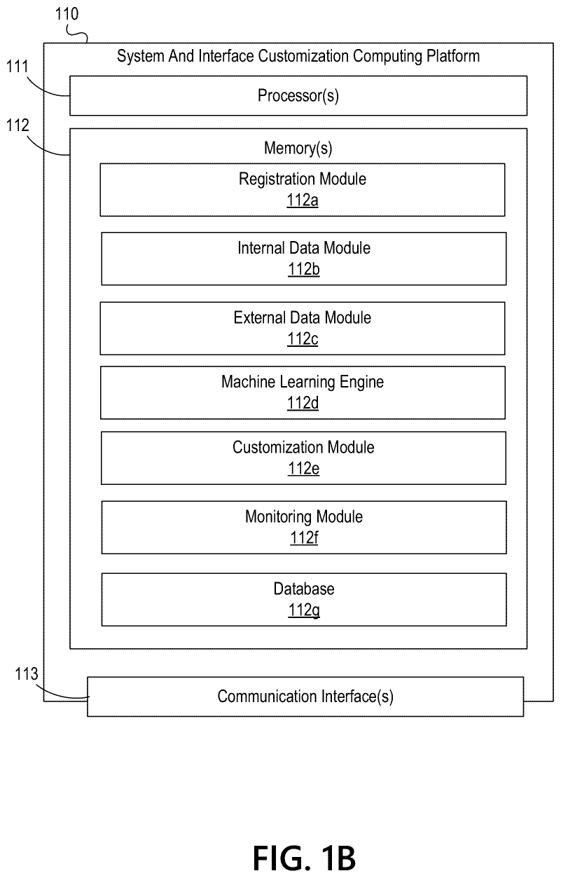

Aspects described herein may be implemented using one or more computing devices operating in a computing environment. For instance, FIGS. 1A-1B depict an illustrative computing environment for implementing enhanced system and user interface customization based on machine-learned context in accordance with one or more aspects described herein. Referring to FIG. 1A, computing environment 100 may include one or more computing devices and/or other computing systems. For example, computing environment 100 may include system and interface customization computing platform 110, internal entity computing system 120, internal entity computing device 130, remote user computing device 150, remote user computing device 155, external entity computing system 160 and external entity computing system 165. Although one internal entity computing system 120, one internal entity computing device 130, two remote user computing devices 150, 155, and two external entity computing systems 160, 165 are shown, any number of devices or systems may be used without departing from the invention.

System and interface customization computing platform 110 may be or include one or more computing devices (e.g., servers, server blades, or the like) and/or one or more computing components (e.g., memory, processor, and the like) and may be configured to provide dynamic, efficient system and user interface customization based on machine-learned context. In some examples, system and interface customization computing platform 110 may receive historical user data associated with user interactions with one or more computing devices, systems, interfaces, or the like. For instance, the historical data may include user demographics, requests for modifications from users, user input indicating positive or negative interactions, and the like. The data may be received from internal sources, such as internal entity computing system 120 and/or external sources, such as external entity computing system 160 and/or external entity computing system 165.

The historical data may be used to train a machine learning model. For instance, in some examples, the historical data may be labeled data indicating user demographics, requested modifications, positive or negative inputs, and the like, and may be used to train the machine learning model to identify patterns or sequences in data and output a recommendation for a modification or customization to a system or interface for a particular user.

In some examples, user specific data may be input into the machine learning model and the model may be executed to output a recommended modification or customization for the user. For instance, a recommendation to modify a font size of a user interface, colors used in a user interface, a volume associated with audio features, a language used, terminology used in communicating with the user, and the like, may be generated based on the analyzed user specific data. The recommendation may be provided to the user who may accept or reject the recommendation. In some examples, acceptance of the recommendation may cause modification to systems or interfaces provided to the user via more than one channel of communication, e.g., a modification at a mobile application may also modify an online application, self-service kiosk interface, or the like.

The system and interface customization computing platform 110 may receive additional user specific data and analyze the data (e.g., using machine learning) to monitor user interactions and generate additional recommendations for modifications or customizations for the user. Accordingly, the system may continuously monitor user interactions with interfaces and systems to identify potential additional modifications to offer to the user or to implement.

Internal entity computing system 120 may be or include one or more computing devices (e.g., servers, server blades, or the like) and/or one or more computing components (e.g., memory, processor, and the like) and may host or execute one or more enterprise organization applications, systems, or the like. Accordingly, internal entity computing system 120 may store user information (e.g., transaction data, product data, demographic data, and the like) that may be used to train the machine learning model. Further, internal entity computing system 120 may store user specific data that may be analyzed using the trained machine learning model to generate one or more recommended system or user interface customizations or modifications.

Internal entity computing device 130 may be or include one or more computing devices, such as desktop computers, laptop computers, tablet computers, smartphones, wearable devices such as smart watches or augmented reality glasses, or the like. In some examples, internal entity computing device 130 may be a self-service kiosk, such as an automated teller machine (ATM), automated teller assistant (ATA), or the like. In some examples, internal entity computing device 130 may be a computing device associated with the enterprise organization but operated by a user (e.g., a customer), such as a tablet device used at a banking center.

Remote user computing device 150 and/or remote user computing device 155 may be or include computing devices such as desktop computers, laptop computers, tablets, smartphones, wearable devices, and the like, that may be associated with a user (e.g., a customer of the enterprise organization). The remote user computing device 150 and/or remote user computing device 155 may be used to request event processing via an online application of the enterprise organization, a mobile application of the enterprise organization, or the like. In some examples, remote user computing device 150 and/or remote user computing device 155 may be configured to communicate with the enterprise organization via a telephone channel and customizations may be provided to the user via the telephone function of remote user computing device 150 or remote user computing device 155. In some examples, remote user computing device 150 may be associated with a same user as remote user computing device 155. In other examples, remote user computing device 150 may be associated with a different user than remote user computing device 155.

External entity computing system 160 and/or external entity computing system 165 may be or include computing devices (e.g., servers, server blades, or the like), components (e.g., processor, memory, or the like), and the like, associated with an entity external to or different from the enterprise organization. External entity computing system 160 and/or external entity computing system 165 may store publicly available data (e.g., tax records, property records, or the like), social media data, or the like, that may be used to train a machine learning model. In some arrangements, external entity computing system 160 and/or external entity computing system 165 may include user specific data that may be analyzed (e.g., using machine learning) to generate one or more recommended modifications or customizations for a system or user interface.

As mentioned above, computing environment 100 also may include one or more networks, which may interconnect one or more of system and interface customization computing platform 110, internal entity computing system 120, internal entity computing device 130, remote user computing device 150, remote user computing device 155, external entity computing system 160 and external entity computing system 165. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, system and interface customization computing platform 110, internal entity computing system 120, and/or internal entity computing device 130, may be associated with an enterprise organization (e.g., a financial institution), and private network 190 may be associated with and/or operated by the organization, and may include one or more networks (e.g., LANs, WANs, virtual private networks (VPNs), or the like) that interconnect system and interface customization computing platform 110, internal entity computing system 120, and/or internal entity computing device 130, and one or more other computing devices and/or computer systems that are used by, operated by, and/or otherwise associated with the organization. Public network 195 may connect private network 190 and/or one or more computing devices connected thereto (e.g., system and interface customization computing platform 110, internal entity computing system 120, internal entity computing device 130) with one or more networks and/or computing devices that are not associated with the organization. For example, remote user computing device 150, remote user computing device 155, external entity computing system 160 and/or external entity computing system 165 might not be associated with an organization that operates private network 190 (e.g., because remote user computing device 150, remote user computing device 155, external entity computing system 160 and/or external entity computing system 165 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect remote user computing device 150, remote user computing device 155, external entity computing system 160 and/or external entity computing system 165 to private network 190 and/or one or more computing devices connected thereto (e.g., system and interface customization computing platform 110, internal entity computing system 120, internal entity computing device 130).

Referring to FIG. 1B, system and interface customization computing platform 110 may include one or more processors 111, memory 112, and communication interface 113. A data bus may interconnect processor(s) 111, memory 112, and communication interface 113. Communication interface 113 may be a network interface configured to support communication between system and interface customization computing platform 110 and one or more networks (e.g., network 190, network 195, or the like). Memory 112 may include one or more program modules having instructions that when executed by processor(s) 111 cause system and interface customization computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of system and interface customization computing platform 110 and/or by different computing devices that may form and/or otherwise make up system and interface customization computing platform 110.

For example, memory 112 may have, store and/or include registration module 112a. Registration module 112a may store instructions and/or data that may cause or enable the system and interface customization computing platform 110 to receive registration data. In some examples, the registration data may include identification of one or more users requesting registration (e.g., providing permission to receive and analyze user specific data to generate recommendations for modifications to systems or user interfaces), one or more user device identifiers, and the like.

System and interface customization computing platform 110 may further have, store and/or include internal data module 112b. Internal data module 112b may store instructions and/or data that may cause or enable the system and interface customization computing platform 110 to receive internal data from one or more internal systems or devices, such as internal entity computing system 120. The data may be received in a data stream, via a batch transfer process, or the like. The data may be used to train a machine learning model. Further, user specific data may be requested from the internal entity computing system 120 and stored by the internal data module 112b for use in analyzing the user specific data to generate one or more recommended system or user interface modifications.

System and interface customization computing platform 110 may further have, store and/or include external data module 112c. External data module 112c may store instructions and/or data that may cause or enable the system and interface customization computing platform 110 to receive external data from one or more external systems or devices, such as external entity computing system 160, external entity computing system 165, or the like. The data may be received in a data stream via a batch transfer process, or the like. The data may be used to train a machine learning model. In some examples, user specific data may be retrieved from the external entity computing system 160 and/or external entity computing system 165 by the external data module and analyzed, using machine learning, to generate one or more system or user interface modifications for execution.

System and interface customization computing platform 110 may further have, store and/or include machine learning engine 112d. Machine learning engine 112d may store instructions and/or data that may cause or enable the system and interface customization computing platform to train, execute, validate and/or update one or more machine learning models that may be used to analyze user specific data to generate one or more system or user interface modifications or customizations. In some examples, the machine learning model may be trained (e.g., using data received from one or more internal data sources, external data sources, and the like) to identify patterns or sequences in data to generate or output a recommended modification or customization. For instance, the machine learning model may receive, as inputs, user specific data for a user and, upon execution of the machine learning model, may output a recommended modification based on identified patterns, sequences, or similarities to training data. In some examples, the user specific data may be received from internal sources (e.g., internal entity computing system 120) and/or external sources (e.g., external entity computing system 160, external entity computing system 165, or the like). The model may be executed based on the inputs to output one or more recommendations. In some examples, a dynamic feedback loop may be used to provide, to the machine learning model, information related to the recommended output, whether it was accepted, and the like, to continuously update the model and improve accuracy of recommendations or optimize outputs of the model.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., data labeled to indicate an demographic data, modification data, or the like).

System and interface customization computing platform 110 may further have, store and/or include customization module 112e. Customization module 112e may store instructions and/or data that may cause or enable the system and interface customization computing platform 110 to generate an instruction causing a system, user interface, or the like, to modify an appearance, functionality, or the like. The generated instruction may be transmitted to a system or device (e.g., internal entity computing system 120, internal entity computing device 130) for execution. In some examples, transmitting the instruction may cause the receiving system or device to automatically execute the instruction, thereby modifying an appearance or functionality of a system or user interface.

System and interface customization computing platform 110 may further have, store and/or include monitoring module 112f. Monitoring module 112f may store instructions and/or data that may cause or enable the system and interface customization computing platform 110 to receive subsequent user specific data and analyze (e.g., using machine learning) the subsequent user data to determine whether additional modifications should be recommended, generate one or more additional modifications, or the like. In some examples, the user data may be continuously or near continuously received, received in real-time or near real-time, or the like, to quickly identify additional modifications for recommendation.

System and interface customization computing platform 110 may further have, store and/or include database 112g. Database 112g may store data associated with historical user data, generated recommendations for modifications or customizations, user specific data, and/or other data that enables performance of the aspects described herein by the system and interface customization computing platform 110.

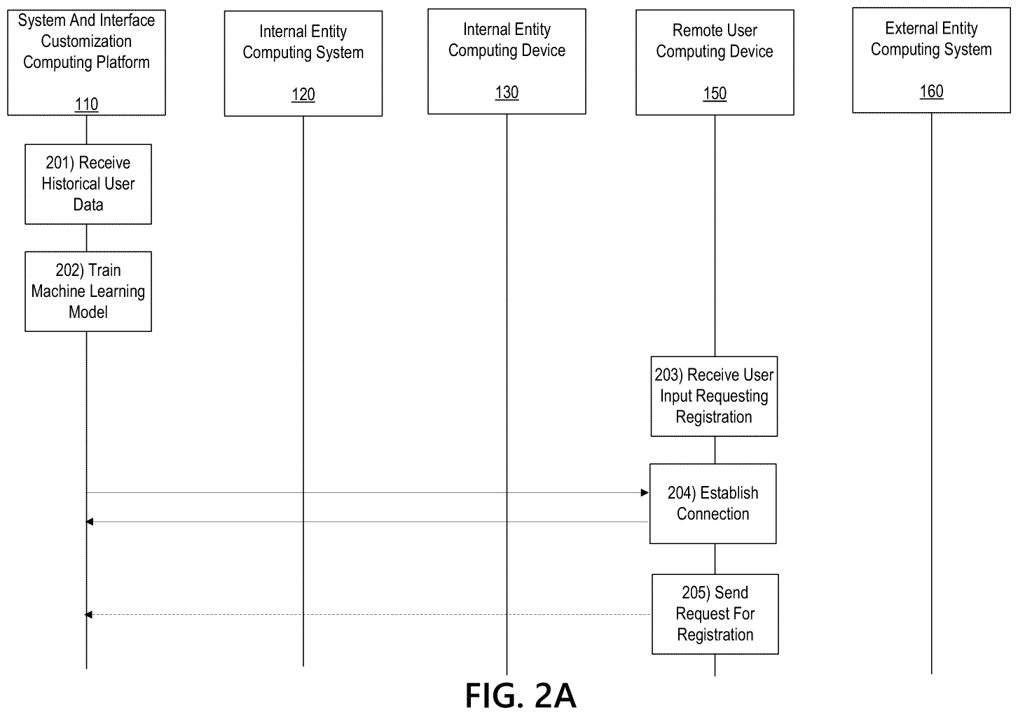

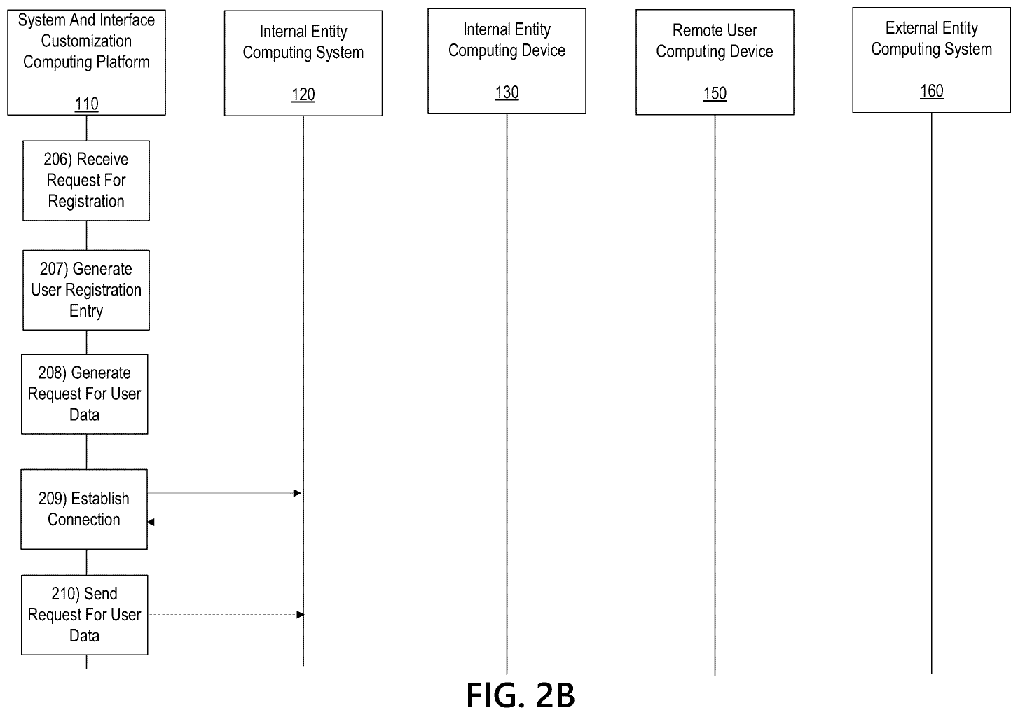

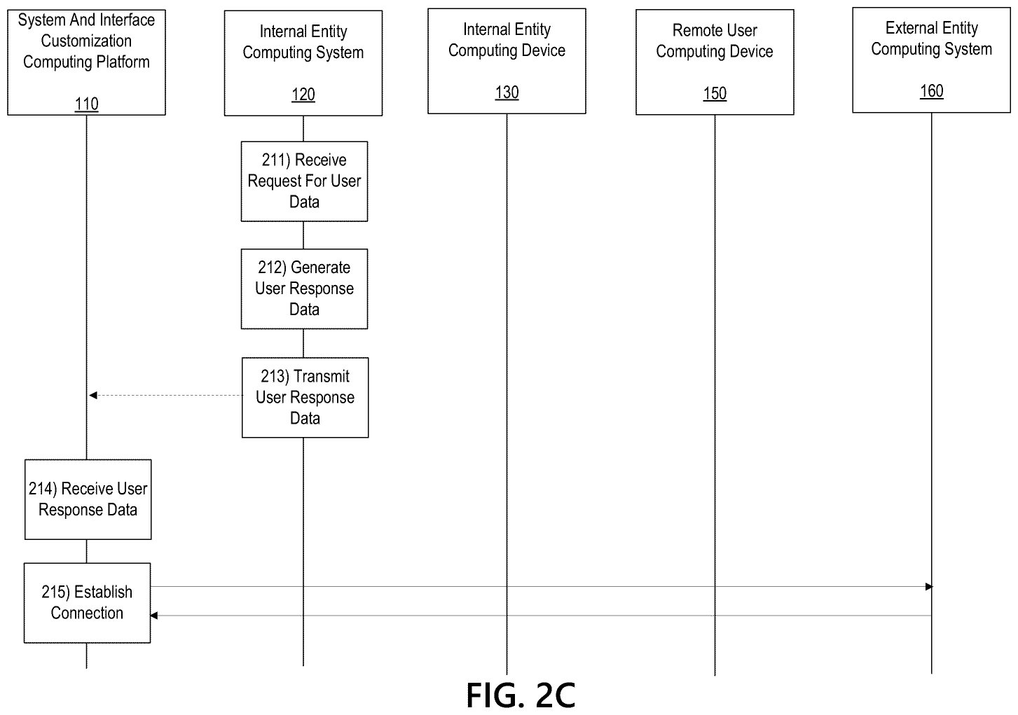

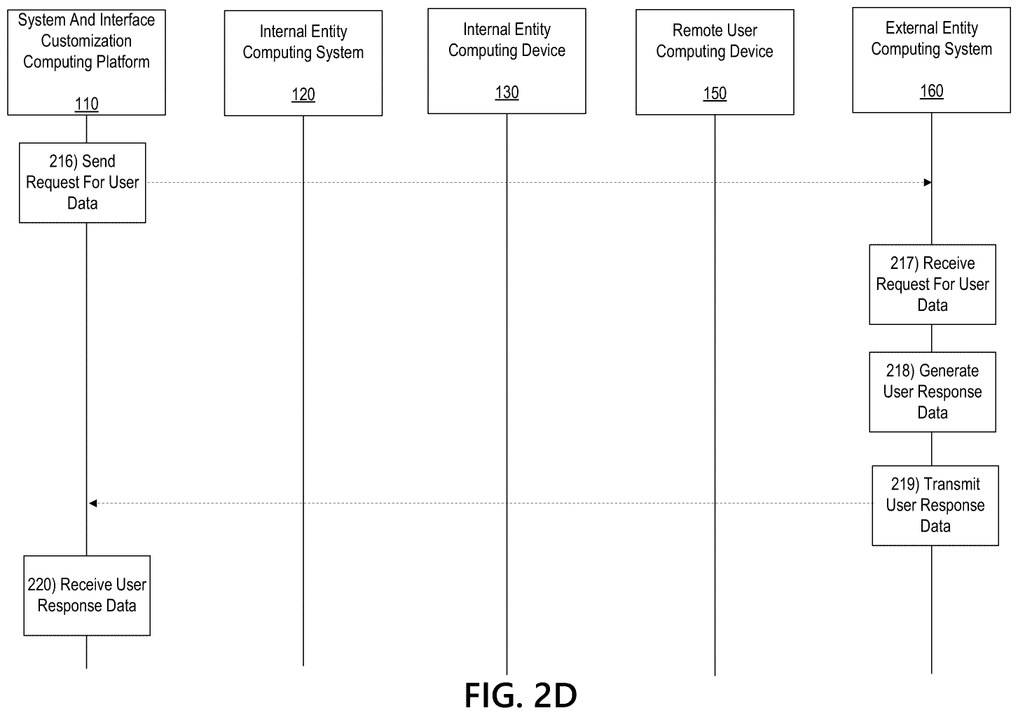

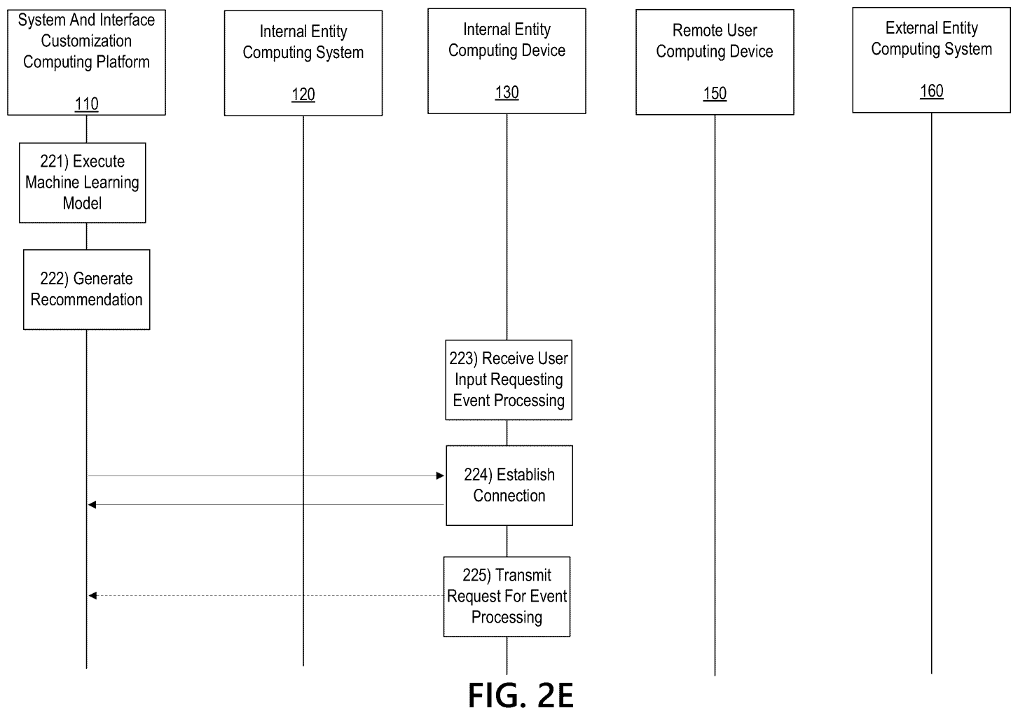

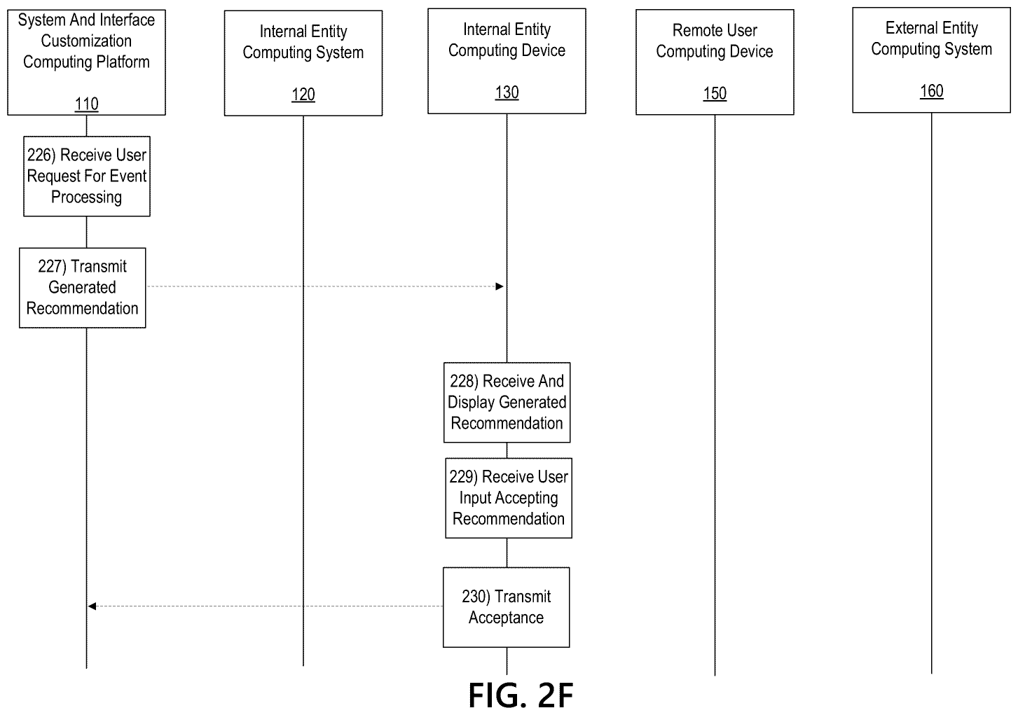

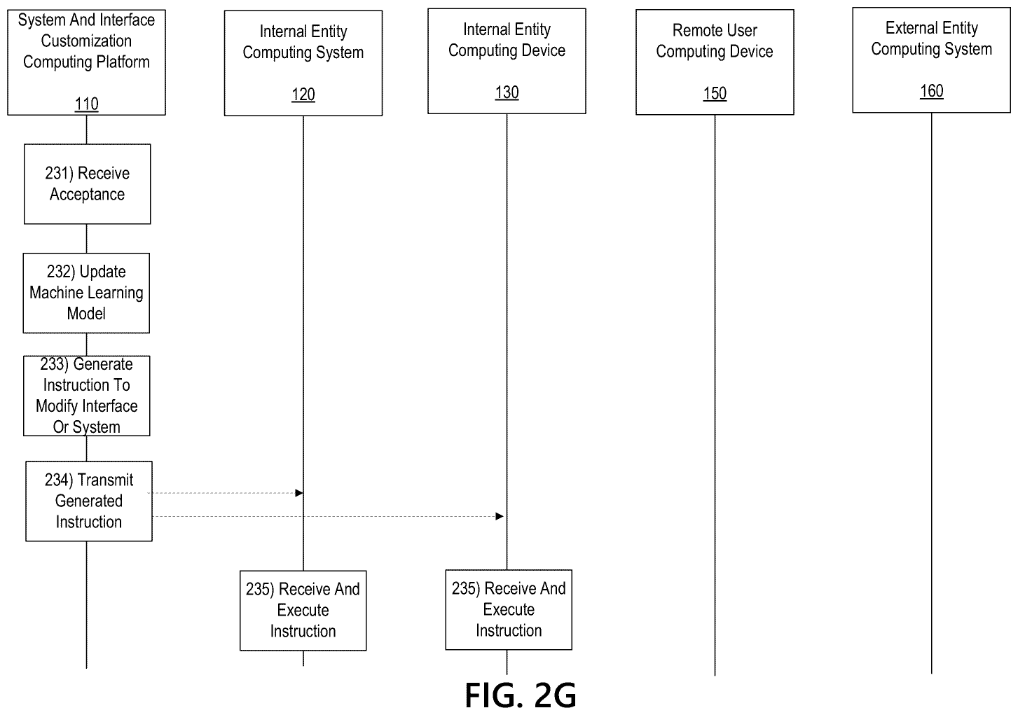

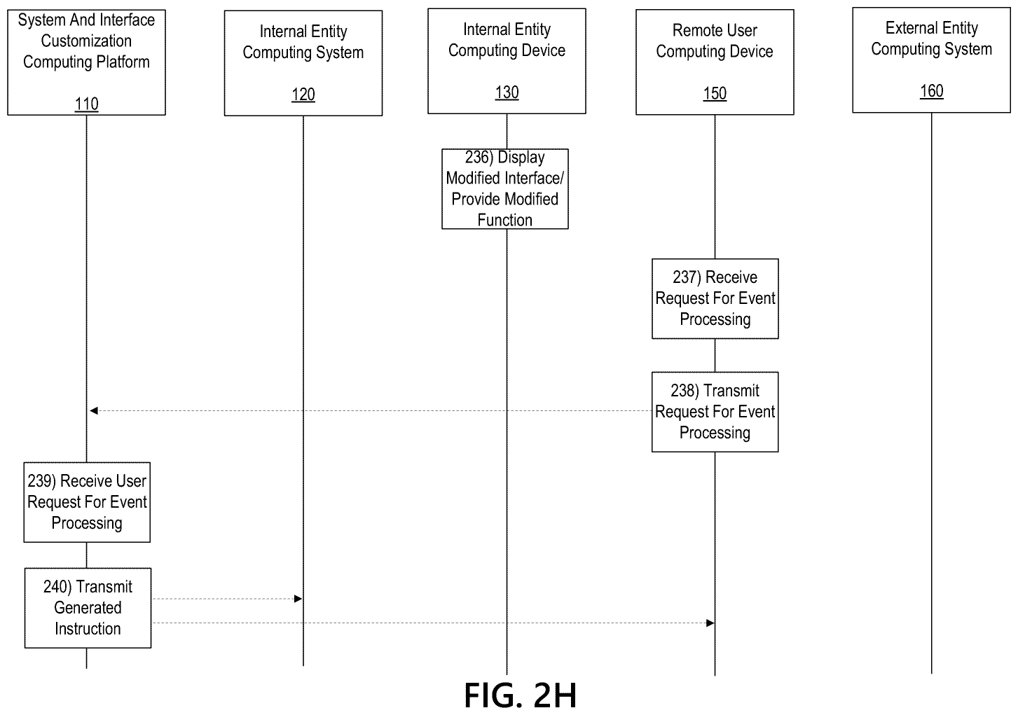

FIGS. 2A-2I depict one example illustrative event sequence for implementing enhanced system and user interface customization based on machine-learned context in accordance with one or more aspects described herein. The events shown in the illustrative event sequence are merely one example sequence and additional events may be added, or events may be omitted, without departing from the invention. Further, one or more processes discussed with respect to FIGS. 2A-2I may be performed in real-time or near real-time.

With reference to FIG. 2A, at step 201, system and interface customization computing platform may receive historical data. As discussed herein, the historical data may include user demographic data, historical requests for modification to one or more systems or user interfaces (e.g., request for larger font, change of color, increased or decreased volume of audio outputs, or the like). In some examples, the historical data may include internal data (e.g., data from one or more systems associated with the enterprise organization, such as internal entity computing system 120) and/or external data (e.g., publicly available data from one or more systems external to the enterprise organization, such as external entity computing system 160, external entity computing system 165, and the like). The data may include publicly available data, such as tax records, social media data, and the like. In some examples, the data received may provide a context for a user (e.g., life stage, interests, job role, hobbies, or the like).

At step 202, the system and interface customization computing platform 110 may train a machine learning model. For instance, the system and interface customization computing platform 110 may train, using the received historical data, the machine learning model to generate one or more recommended system or user interface modifications for a user. In some examples, training the machine learning model may include using labeled data (e.g., demographic, hobby, positive or negative response, requested modification, or the like) to train the machine learning model to identify patterns or sequences in user specific data in order to output a recommended system or user interface modification for the user.

At step 203, a remote user computing device 150 may receive user input requesting registration with the system and interface customization computing platform 110. For instance, remote user computing device 150 may receive user input via a touchscreen, keypad, or the like, and from a user associated with remote user computing device 150, a request to register with the system and interface customization computing platform 110. In some examples, the request for registration may include user permissions for the system and interface customization computing platform 110 to receive and analyze user specific data to generate one or more recommendations. The request for registration may further include user identifying data, user device identifying data, and the like.

At step 204, remote user computing device 150 may establish a connection with the system and interface customization computing platform 110. For instance, a first wireless connection may be established between the remote user computing device 150 and the system and interface customization computing platform 110. Upon establishing the first wireless connection, a communication session may be initiated between the remote user computing device 150 and the system and interface customization computing platform 110.

At step 205, remote user computing device 150 may transmit or send the request for registration to the system and interface customization computing platform 110. For instance, the remote user computing device 150 may transmit or send the request for registration during the communication session initiated upon establishing the first wireless connection.

With reference to FIG. 2B, at step 206, the system and interface customization computing platform 110 may receive the request for registration.

At step 207, the system and interface customization computing platform 110 may generate a user registration entry in response to receiving the request for registration. For instance, system and interface customization computing platform 110 may modify a database (e.g., database 112g) to include user registration data, user permission data, and the like.

At step 208, system and interface customization computing platform 110 may generate a request for user specific data. For instance, the system and interface customization computing platform 110 may generate a request for user specific data associated with the user associated with the request for registration. The request for user specific data may include a request for internal data (e.g., user transaction data, system or interface modification requests, demographic data, and the like) and/or external data (e.g., social media data, property record data, and the like).

At step 209, system and interface customization computing platform 110 may establish a connection with the internal entity computing system 120. For instance, a second wireless connection may be established between the system and interface customization computing platform 110 and internal entity computing system 120. Upon establishing the second wireless connection, a communication session may be initiated between the system and interface customization computing platform 110 and the internal entity computing system 120.

At step 210, system and interface customization computing platform 110 may transmit or send the request for user specific data to the internal entity computing system 120. For instance, the system and interface customization computing platform 110 may transmit or send the request for user specific data during the communication session initiated upon establishing the second wireless connection.

With reference to FIG. 2C, at step 211, internal entity computing system 120 may receive the request for user specific data. In response to receiving the request, internal entity computing system 120 may identify user specific data associated with the user (e.g., transaction data, demographic data, and the like).

At step 212, internal entity computing system 120 may generate user specific response data. For instance, based on the identified data, the internal entity computing system 120 may generate user specific response data.

At step 213, internal entity computing system 120 may transmit or send the user specific response data to the system and interface customization computing platform 110.

At step 214, system and interface customization computing platform 110 may receive the user specific response data transmitted by the internal entity computing system 120.

At step 215, system and interface customization computing platform 110 may establish a connection with the external entity computing system 160. For instance, a third wireless connection may be established between the system and interface customization computing platform 110 and external entity computing system 160. Upon establishing the third wireless connection, a communication session may be initiated between the system and interface customization computing platform 110 and the external entity computing system 160.

With reference to FIG. 2D, at step 216, system and interface customization computing platform 110 may transmit or send the request for user specific data to the external entity computing system 160. For instance, the system and interface customization computing platform 110 may transmit or send the request for user specific data during the communication session initiated upon establishing the third wireless connection.

At step 217, external entity computing system 160 may receive the request for user specific data. In response to receiving the request, external entity computing system 160 may identify user specific data associated with the user (e.g., public records data, social media data, and the like).

At step 218, external entity computing system 160 may generate user specific response data. For instance, based on the identified data, the external entity computing system 160 may generate user specific response data.

At step 219, external entity computing system 160 may transmit or send the user specific response data to the system and interface customization computing platform 110.

At step 220, system and interface customization computing platform 110 may receive the user specific response data transmitted by the external entity computing system 160.

Although requests for user data are shown as being sent to one internal entity computing system 120 and one external entity computing system 160, requests for user data may be sent to additional internal and/or external devices or systems without departing from the invention.

With reference to FIG. 2E, at step 221, system and interface customization computing platform 110 may execute the machine learning model. For instance, system and interface customization computing platform 110 may input, to the machine learning model, the received user specific response data. The machine learning model may be executed and the user specific response data analyzed to identify patterns or sequences in the data in order to output one or more recommendations for system or user interface modifications.

At step 222, the system and interface customization computing platform 110 may generate a recommended system or user interface modification (e.g., based on an output from the machine learning model).

At step 223, internal entity computing device 130 may receive a request for event processing from a user. The user may be a user registered with the system and interface customization model and, for instance, may be the user requesting registration in step 203 and for whom the recommendation was generated at step 222. In some examples, internal entity computing device 130 may be a self-service kiosk and the request for event processing may include a transaction such as withdrawal, deposit, balance inquiry, transfer, or the like. In some examples, the request for event processing may include user identifying information, device identifying information, type of device, event details, and the like.

At step 224, internal entity computing device 130 may establish a connection with the system and interface customization computing platform 110. For instance, a fourth wireless connection may be established between the internal entity computing device 130 and the system and interface customization computing platform 110. Upon establishing the fourth wireless connection, a communication session may be initiated between the internal entity computing device 130 and the system and interface customization computing platform 110.

At step 225, internal entity computing device 130 may transmit or send the request for event processing to the system and interface customization computing platform 110. For instance, the internal entity computing device 130 may transmit or send the request for event processing during the communication session initiated upon establishing the fourth wireless connection.

With reference to FIG. 2F, at step 226, system and interface customization computing platform 110 may receive the request for event processing and may process the event. In some examples, processing the event may include identifying the recommendation generated for the user (e.g., at step 222). In some examples, processing the request for event processing may include executing the machine learning model for the user including the event details, device details, and the like, to further generate or refine the recommendation.

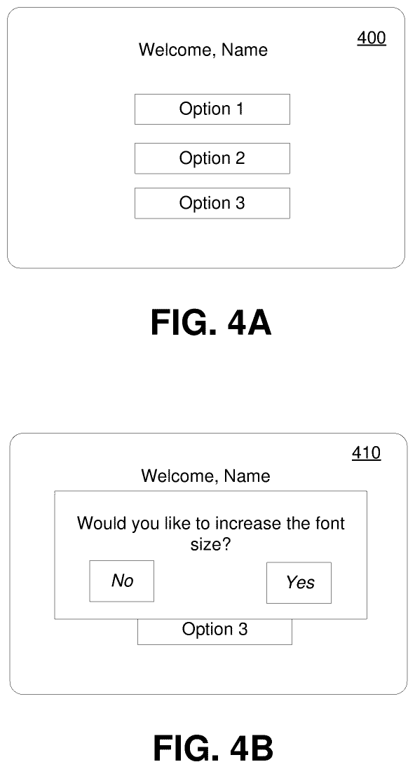

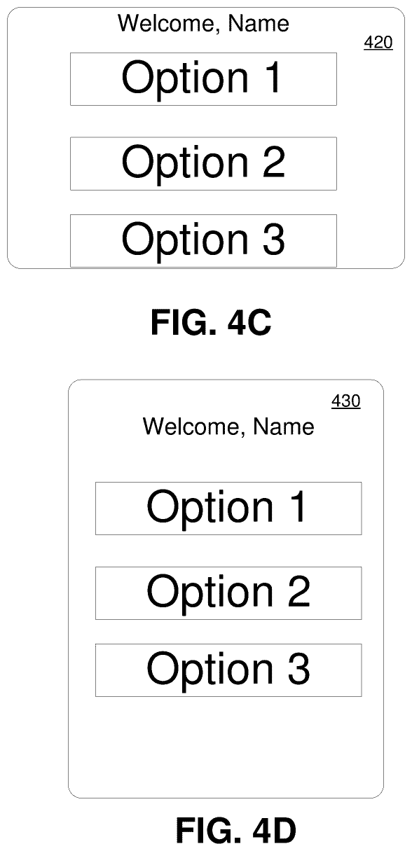

At step 227, system and interface customization computing platform 110 may transmit or send the generated recommendation to the internal entity computing device 130. In some examples, the generated recommendation may include an instruction or command causing a notification to be displayed to a user. The notification may include a request for acceptance of a recommendation. For instance, FIG. 4A illustrates one example standard or non-modified user interface 400 of a self-service kiosk (e.g., internal entity computing device 130).

At step 228, the internal entity computing device 130 may receive and display the generated recommendation. For instance, FIG. 4B includes a user interface 410 including a recommendation to increase a font size of a display. The interface 410 may include a request for acceptance or rejection of the recommendation by the user.

At step 229, internal entity computing device 130 may receive user input selecting acceptance of the generated recommendation. For instance, the user may select “yes” option in interface 410 in FIG. 4B and a signal indicating acceptance may be received by internal entity computing device 130.

At step 230, internal entity computing device 130 may transmit or send acceptance of the generated recommendation to the system and interface customization computing platform 110.

With reference to FIG. 2G, at step 231, system and interface customization computing platform 110 may receive the acceptance of the recommendation transmitted or sent by the internal entity computing device 130.

At step 232, system and interface customization computing platform 110 may update or validate the machine learning model based on the generated recommendation and received acceptance of the generated recommendation. Accordingly, the machine learning model may be continually updated to improve accuracy or optimize recommendations generated.

At step 233, system and interface customization computing platform 110 may generate an instruction to modify an interface or system. For instance, based on acceptance of the recommended modification, the system and interface customization computing platform 110 may generate an instruction or command causing one or more systems or devices to modify a display, functionality, or the like, of a system, user interface, or the like.

At step 234, system and interface customization computing platform 110 may transmit or send the generated instruction or command to one or more computing devices or systems. For instance, system and interface customization computing platform 110 may transmit or send the instruction to one or more back end systems, such as internal entity computing system 120, as well as the device at which the request for event processing was received, e.g., internal entity computing device 130.

At step 235, the one or more devices to which the instruction for modification was sent may receive the instruction and execute the instruction. For instance, in some examples, transmitting the instruction to the one or more devices (e.g., internal entity computing system 120 and/or internal entity computing device 130) may cause the receiving device or system to automatically execute the instruction, thereby modifying the system or interface.

With reference to FIG. 2H, at step 236, internal entity computing device 130 may display the modified interface and/or modified functionality of the device (e.g., based on execution of the instruction to modify the system or interface). FIG. 4C illustrates one examples user interface 420 that includes a modified user interface. As shown in FIG. 4C, the font size has increased in the modified interface 420 from the font size shown in FIG. 4A. Modifying font size is merely one example modification or a display or functionality. Various other modifications may be recommended and executed without departing from the invention.

At step 237, a subsequent request for event processing may be received by a different device from the user. For instance, remote user computing device 150 may be a mobile device of the user and may receive a request for event processing (e.g., execute a mobile banking application to cash a check, request a balance inquiry, review transactions, or the like). In some examples, the request for event processing may include user identifying information, event details, and the like).

At step 238, the remote user computing device 150 may transmit or send the request for event processing to the system and interface customization computing platform 110.

At step 239, the system and interface customization computing platform 110 may receive the request for event processing from the remote user computing device and may process the request. In some examples, processing the request may include analyzing the user and/or event data to generate a recommendation. Additionally or alternatively, processing the request may include retrieving previously accepted modification recommendations of the user for execution by the device from which the subsequent request for event processing was received.

For instance, at step 240, system and interface customization computing platform 110 may transmit or send the instruction to execute the recommendation generated at step 222 and accepted by the user to one or more devices or systems for execution. For instance, system and interface customization computing platform 110 may transmit or send the generated instruction to a back end system (e.g., internal entity computing system 120) and/or the device from which the request for event processing was received (e.g., remote user computing device 150).

With reference to FIG. 2I, at step 241, the one or more devices to which the instruction for modification was sent may receive the instruction and execute the instruction. For instance, in some examples, transmitting the instruction to the one or more devices (e.g., internal entity computing system 120 and/or remote user computing device 150) may cause the receiving device or system to automatically execute the instruction, thereby modifying the system or interface.

At step 242, remote user computing device 150 may display the modified interface and/or modified functionality of the device (e.g., based on execution of the instruction to modify the system or interface). FIG. 4D illustrates one example user interface 430 that includes a modified user interface. As shown in FIG. 4D, the font size shown is the increased font size, similar to the increased font size in FIG. 4C. Accordingly, the generated recommendation may be used to modify systems or interfaces across multiple devices, types of devices, and the like.

The system and interface customization computing platform 110 may further monitor user activity, and the like, to identify additional recommendations for modifications to systems and/or interfaces. For instance, at step 243, additional user specific data may be received from one or more sources, such as internal entity computing system 120 and/or external entity computing system 160. The additional user specific data may include updated transactions, user interactions, social media data, and the like.

At step 244, system and interface customization computing platform 110 may execute the machine learning model using the additional user specific data as inputs to output another recommended modification and/or an updated recommended modification. At step 245, based on execution of the machine learning model, one or more additional recommendations for modifications to systems or interfaces may be generated. The process may continue similar to the process described by offering the additional recommendation to the user, receiving acceptance rejection, and the like.

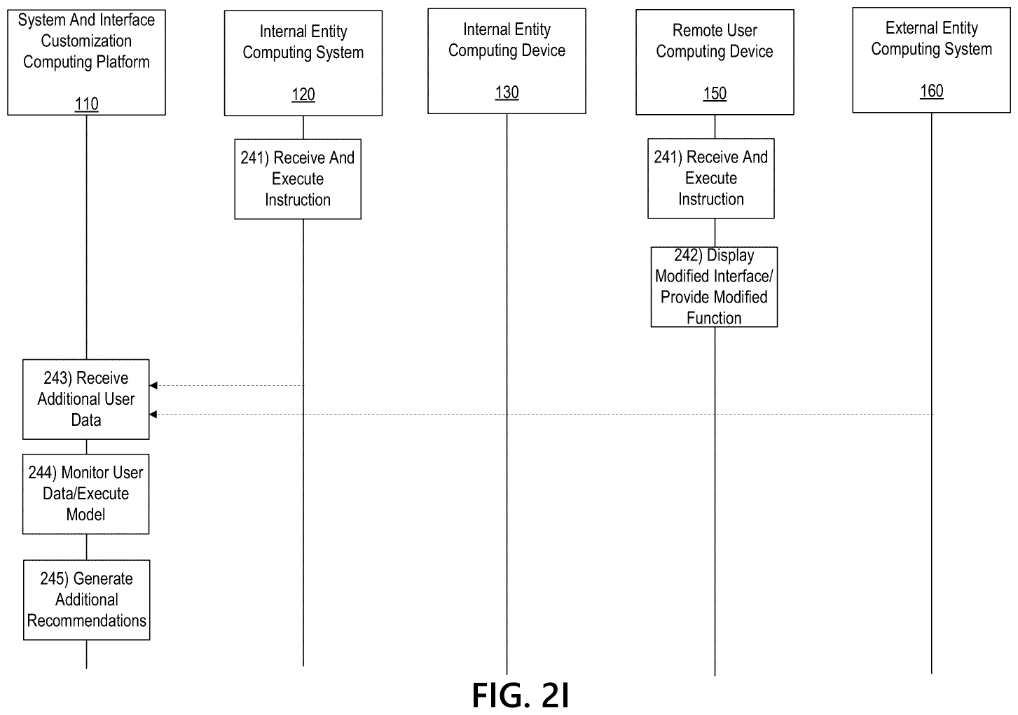

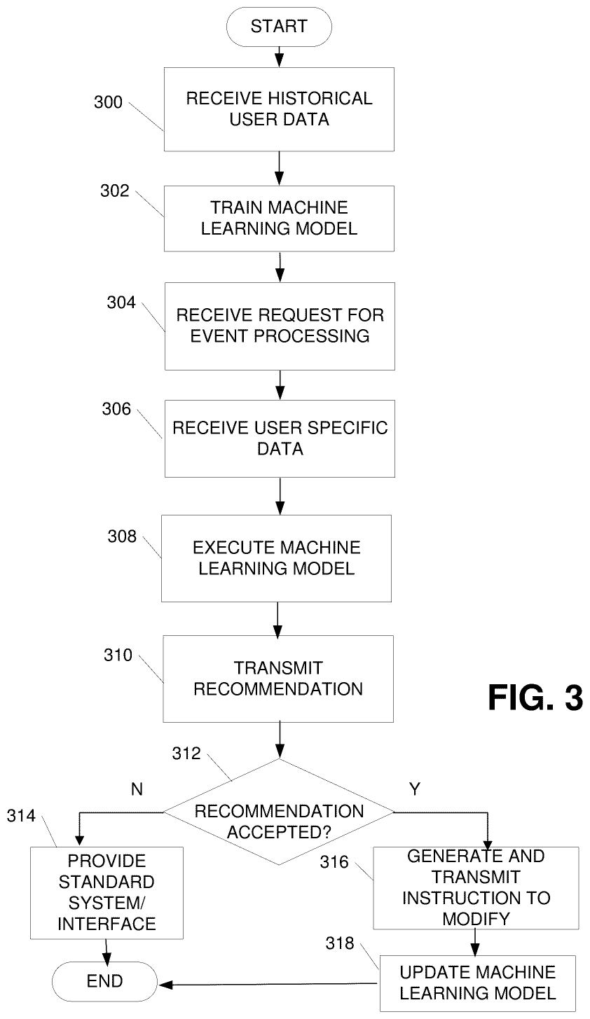

FIG. 3 is a flow chart illustrating one example method of enhanced system and graphical user interface customization based on machine-learned context in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive, from a plurality of data sources, historical user data. For instance, historical user data associated with transaction histories, modifications requested, interests, hobbies, job function, demographics, public records, and the like, may be received by the computing platform 110. Accordingly, the plurality of data sources may include internal data sources (e.g., internal to the enterprise organization associated with the computing platform 110), and/or external data sources (e.g., sources external to the enterprise organization).

At step 302, the computing platform may train a machine learning model using the received historical data. For instance, the machine learning model may be trained identify patterns or sequences in data based on the historical data received. The machine learning model may be trained to receive user specific data as inputs and output one or more recommended modifications to a system or user interface.

At step 304, a request for event processing may be received by the computing platform 110. For instance, a first computing device may receive a request from a user to process an event. In some examples, the first computing device may be a first type of device (e.g., self-service kiosk associated with the enterprise organization, mobile terminal of the enterprise organization, mobile device associated with the user, other computing device associated with the user, and the like).

At step 306, the computing platform may retrieve user specific data associated with the user. For instance, internal data sources (e.g., internal entity computing system 120) and external data sources (e.g., external entity computing system 160 and/or external entity computing system 165) may provide user specific data associated with the user requesting event processing. In some examples, the user specific data may be identified from the request for event processing. In other examples, a user identity may be provided to identify the user specific data and a user may request an event for processing after the user specific data has been received by the computing platform 110.

At step 308, the computing platform may execute the machine learning model. For instance, the user specific data and/or requested event details may be input into the machine learning model. Upon execution of the machine learning model, the model may output a recommendation for one or more modifications to at least one of a system or a user interface.

At step 310, the computing platform 110 may transmit the generated recommendation to one or more computing devices or systems. For instance, the computing platform may transmit or send the generated recommendation to the first computing device. In some examples, transmitting or sending the generated recommendation may cause display of the recommendation on a display of the first user computing device. As discussed herein, the recommendation may include user selectable interface elements to accept or rejected the recommendation.

At step 312, a determination may be made as to whether the user accepted the recommendation. If not, the system may provide standard or default functionality, user interfaces, or the like at step 314. In examples in which a user has accepted a previously generated modification, the standard or default functionality, user interface, or the like, may include the previously accepted recommended modification.

If, at step 312, the recommended modification is accepted by the user, the computing platform 110 may generate an instruction causing modification of one or more systems, user interfaces, or the like at step 316. For instance, the computing platform 110 may generate an instruction causing modification of a functionality or display of one or more systems or user interfaces. The instruction may be transmitted to one or more devices or systems for execution. For instance, the instruction may be transmitted to first computing device to modify components or aspects executing on the first computing device. Additionally or alternatively, the instruction may be transmitted to a back end system or server (e.g., internal entity computing system 120 that may host or execute one or more applications or systems of the enterprise organization). In some examples, transmitting the instruction may cause the instruction to automatically execute on the receiving device or system.

At step 318, based on the generated recommendation and user input accepting or rejecting the modification, the machine learning model may be updated or validated. Accordingly, the machine learning model may be continuously updated to provide improved accuracy in generating user specific enhanced customization recommendations for one or more systems or user interfaces.

As discussed, aspects described herein are directed to using machine-learned contextual data to identify recommended, user specific modifications to a system or user interface. By analyzing user specific data from a plurality of data sources, the system may generate suggested modifications that are unique to the user, needs of the user, interests of the user, and the like. This may provide a more customized overall interaction experience for a user.

For instance, customized options, appearances, functionality, and the like, may be provided to users of self-service kiosks of an enterprise organization, mobile terminals of the enterprise organization, as well as online or mobile applications of the enterprise organization. In some examples, modifications made to one channel or computing device may be executed to modify systems or interfaces accessed via other channels or computing devices.

Aspects described herein may be useful to diverse populations, vulnerable populations, and the like, who may have difficulty interacting via standard or conventional systems or interfaces. The arrangements described provide user specific customization options to accommodate particular desired terminology, language preferences, language stylistic preferences, dialects, speech patterns, speed of audio, displays and the like. By customizing based on contextual user data, language preferences may include a preferred language or dialect for users who speak more than one language or dialect.

In some examples, language preferences may be customized by linking or connecting a mobile device of a user (e.g., remote user computing device 150) to a computing device of the enterprise organization (e.g., internal entity computing device 130). For instance, a Bluetooth or other short range communication connection may be established to provide a communication link between the devices. Audio in the desired language, dialect, or the like may be provided via the mobile device of the user and/or one or more user interfaces including the desired language or dialect preferences may be rendered on the mobile device based on instructions received from the internal entity computing device 130. Accordingly, in some examples, visual and/or audio feedback may be customized.

As discussed herein, user input indicating positive or negative feedback may be used to train the machine learning model. In some examples, positive or negative feedback may be used to generate additional recommendations (e.g., update or validate the machine learning model). For instance, if a particular speech pattern received positive feedback from a user, that speech pattern may be used or recommended to interact with the user via all channels and computing devices. Accordingly, the speech pattern may be modified from the standard pattern to the modified pattern for the user when communicating via all channels.

While customization aspects described herein may monitored to identify additional recommended modifications, in some examples, a user may provide input to identify and select a particular modification or remove a previous modification. In some examples, a user may select to have different modifications based on the channel or computing device. For instance, for self-service kiosk interactions, a user may select one recommended modification but might remove it or not select it for a mobile device of the user. Accordingly, the user may control or change modifications executed.

In some examples, arrangements provided herein may be used in authenticating a user. For instance, a customized image or biometric data may be used as a second factor of authentication. In some examples, an avatar, work of art, or the like, may be used in the authentication. In some examples, a user may upload or otherwise select an image for use.

In some arrangements, prior to a first recommended modification, a user may receive standard systems, functionality, displays of user interfaces, and the like. The user specific data may then be analyzed to identify one or more modifications and the user specific data may further be monitored to generate additional recommendations. In some examples, one or more templates may be generated. A template may include one or more system or user interface modifications for a category of user (e.g., artist, musician, retiree, young adult, or the like). The category of user may be determined from user specific data or may be self-identified by the user. The template may be selected by or for the user and one or more associated modifications may be recommended and/or executed. As user specific data is analyzed, additional modifications to the template may be recommended and/or executed to further customize systems, functions and/or user interfaces for a particular user.

In some examples, acceptance of one modification may be used by the machine learning model to generate a related second modification. For instance, if a user selects to increase volume of audio output, the machine learning model may generate a second recommended modification to slow down the pace of the speaker's voice.

In some examples, a geographic location of a user may be considered in identifying a recommended modification. For instance, geolocation data of a user (e.g., as received from, for instance, a remote user computing device 150) may be analyzed with user specific data to determine modifications appropriate for the location. For instance, if in a public space and using audio output, a recommended modification to reduce volume, activate a headset or headphones, or the like, may be generated.

In some arrangements, modifications recommended, accepted, rejected, and the like, may be stored in a log. The log may identify changes made, users or devices associated with accepted modifications, and the like. In some examples, this change log may be accessible to a user to identify any modifications made by unauthorized actors.

In some examples, in monitoring the modifications made, an alert may be generated and transmitted to a user if a modification is outside an expected modification for the user. In some examples, the alert may include contacting a user via pre-registered contact information, transmitting an electronic communication, limiting access to accounts or functionality, or the like.

As discussed herein, social media data may be used to train a machine learning model, may be used as user specific inputs to output a recommendation, and the like. Accordingly, if similarly situated users are requesting particular modifications or accepting particular modifications, similar modifications may be recommended for a user based, e.g., on fitting a similar profile (e.g., based on social media and other data). Further, while recommendations to font size, and the like are discussed, the particular arrangement of options may be modified for a user to enable the user to more easily identify desired options.

In some examples, the arrangements described herein may enable users to select customized images for display on enterprise organization website associated with the user (e.g., an online or mobile application landing page for a user). In some examples, a user may upload an image that may be used in a background to add an additional customized feel.

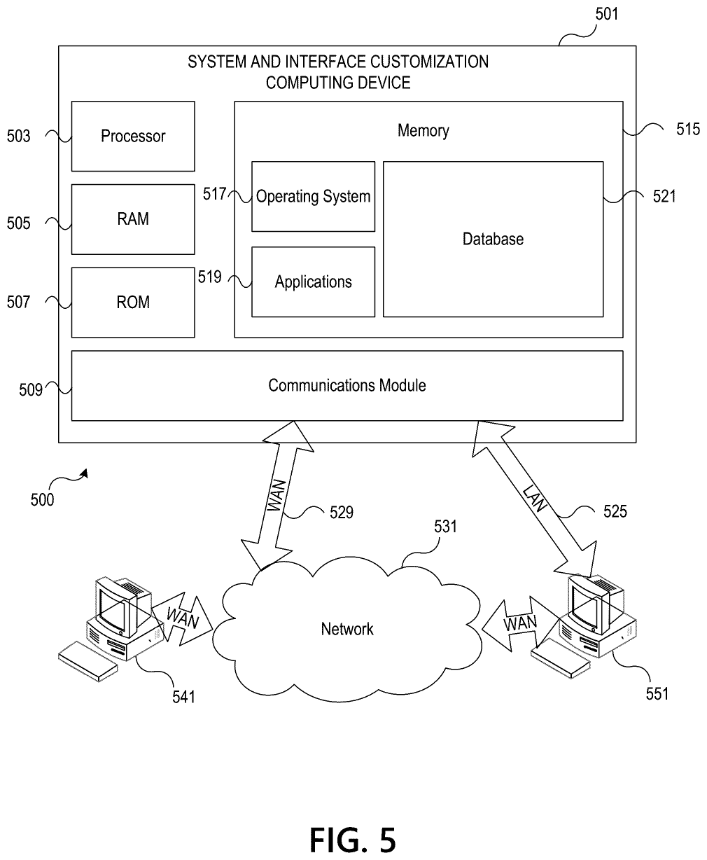

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include system and interface customization computing device 501 having processor 503 for controlling overall operation of system and interface customization computing device 501 and its associated components, including Random Access Memory (RAM) 505, Read-Only Memory (ROM) 507, communications module 509, and memory 515. System and interface customization computing device 501 may include a variety of computer readable media. Computer readable media may be any available media that may be accessed by system and interface customization computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by system and interface customization computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on system and interface customization computing device 501. Such a processor may execute computer-executable instructions stored on a computer-readable medium.

Software may be stored within memory 515 and/or storage to provide instructions to processor 503 for enabling system and interface customization computing device 501 to perform various functions as discussed herein. For example, memory 515 may store software used by system and interface customization computing device 501, such as operating system 517, application programs 519, and associated database 521. Also, some or all of the computer executable instructions for system and interface customization computing device 501 may be embodied in hardware or firmware. Although not shown, RAM 505 may include one or more applications representing the application data stored in RAM 505 while system and interface customization computing device 501 is on and corresponding software applications (e.g., software tasks) are running on system and interface customization computing device 501.

Communications module 509 may include a microphone, keypad, touch screen, and/or stylus through which a user of system and interface customization computing device 501 may provide input, and may also include one or more of a speaker for providing audio output and a video display device for providing textual, audiovisual and/or graphical output. Computing system environment 500 may also include optical scanners (not shown).

System and interface customization computing device 501 may operate in a networked environment supporting connections to one or more other computing devices, such as computing device 541 and 551. Computing devices 541 and 551 may be personal computing devices or servers that include any or all of the elements described above relative to system and interface customization computing device 501.

The network connections depicted in FIG. 5 may include Local Area Network (LAN) 525 and Wide Area Network (WAN) 529, as well as other networks. When used in a LAN networking environment, system and interface customization computing device 501 may be connected to LAN 525 through a network interface or adapter in communications module 509. When used in a WAN networking environment, system and interface customization computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive historical user data from a plurality of data sources, wherein the historical user data is captured via a plurality of computing devices;
train, using the historical user data, a machine learning model to generate recommended modifications of at least one of: a system or a user interface, wherein the recommended modification of the at least one of: the system or the user interface includes modifying at least one of: functionality or a display of the at least one of: the system or the user interface;
receive, from a user and via a first computing device, a user request for event processing;
receive, from at least one data source of the plurality of data sources, user specific data associated with the user;
execute the machine learning model, wherein executing the machine learning model includes using, as inputs, the user specific data, to output a first recommended modification of the at least one of: the system or the user interface;
transmit, to the first computing device, the first recommended modification, wherein transmitting the first recommended modification causes the first computing device to display the first recommended modification of the at least one of: the system or the user interface;
receive, from the first computing device, acceptance of the first recommended modification of the at least one of: the system or the user interface;
generate an instruction to modify the at least one of: the system or the user interface based on the acceptance of the first recommended modification of the at least one of: the system or the user interface;
transmit, to at least the first computing device, the instruction to modify the at least one of: the system or the user interface, wherein transmitting the instruction to modify the at least one of: the system or the user interface causes the first computing device to execute the instruction and modify the at least one of: the system or the user interface; and
update, based on at least the first recommended modification of the at least one of: the system or the user interface, the machine learning model.

2. The computing platform of claim 1, wherein the plurality of data sources includes internal data sources and external data sources.

3. The computing platform of claim 1, further including instructions that, when executed, cause the computing platform to:
receive, from the user and via a second computing device, a subsequent request for event processing; and
transmit, to at least the second computing device, the instruction to modify the at least one of: the system or the user interface, wherein transmitting the instruction to modify the at least one of: the system or the user interface causes the second computing device to execute the instruction and modify the at least one of: the system or the user interface.

4. The computing platform of claim 3, wherein the first computing device is a self-service kiosk of an enterprise organization and the second computing device is a mobile device of the user.

5. The computing platform of claim 1, further including instructions that, when executed, cause the computing platform to:
receive, from the at least one data source, additional user specific data; and
execute the machine learning model, wherein executing the machine learning model includes using, as inputs, the additional user specific data, to output a second recommended modification of the at least one of: the system or the user interface.

6. The computing platform of claim 1, wherein the first recommended modification of the at least one of: the system or the user interface includes a modification of at least one of: a font size, a volume of audio output, a number of functions available, and terminology provided to the user.

7. The computing platform of claim 1, wherein transmitting, to at least the first computing device, the instruction to modify the at least one of: the system or the user interface further includes transmitting the instruction to a back end server, wherein transmitting the instruction to the back end server causes the back end server to execute the instruction and modify the at least one of: the system or the user interface.

8. A method, comprising:
receiving, by a computing platform, the computing platform having at least one processor and memory, and from a plurality of data sources, historical user data, wherein the historical user data is captured via a plurality of computing devices;
training, by the at least one processor and using the historical user data, a machine learning model to generate recommended modifications of at least one of: a system or a user interface, wherein the recommended modification of the at least one of: the system or the user interface includes modifying at least one of: functionality or a display of the at least one of: the system or the user interface;
receiving, by the at least one processor and from a user via a first computing device, a user request for event processing;
receiving, by the at least one processor and from at least one data source of the plurality of data sources, user specific data associated with the user;
executing, by the at least one processor, the machine learning model, wherein executing the machine learning model includes using, as inputs, the user specific data, to output a first recommended modification of the at least one of: the system or the user interface;
transmitting, by the at least one processor and to the first computing device, the first recommended modification, wherein transmitting the first recommended modification causes the first computing device to display the first recommended modification of the at least one of: the system or the user interface;
receiving, by the at least one processor and from the first computing device, acceptance of the first recommended modification of the at least one of: the system or the user interface;
generating, by the at least one processor, an instruction to modify the at least one of: the system or the user interface based on the acceptance of the first recommended modification of the at least one of: the system or the user interface;
transmitting, by the at least one processor and to at least the first computing device, the instruction to modify the at least one of: the system or the user interface, wherein transmitting the instruction to modify the at least one of: the system or the user interface causes the first computing device to execute the instruction and modify the at least one of: the system or the user interface; and
updating, by the at least one processor and based on at least the first recommended modification of the at least one of: the system or the user interface, the machine learning model.

9. The method of claim 8, wherein the plurality of data sources includes internal data sources and external data sources.

10. The method of claim 8, further including:
receiving, by the at least one processor and from the user via a second computing device, a subsequent request for event processing; and
transmitting, by the at least one processor and to at least the second computing device, the instruction to modify the at least one of: the system or the user interface, wherein transmitting the instruction to modify the at least one of: the system or the user interface causes the second computing device to execute the instruction and modify the at least one of: the system or the user interface.

11. The method of claim 10, wherein the first computing device is a self-service kiosk of an enterprise organization and the second computing device is a mobile device of the user.

12. The method of claim 8, further including:
receiving, by the at least one processor and from the at least one data source, additional user specific data; and
executing, by the at least one processor, the machine learning model, wherein executing the machine learning model includes using, as inputs, the additional user specific data, to output a second recommended modification of the at least one of: the system or the user interface.

13. The method of claim 8, wherein the first recommended modification of the at least one of: the system or the user interface includes a modification of at least one of: a font size, a volume of audio output, a number of functions available, and terminology provided to the user.

14. The method of claim 8, wherein transmitting, to at least the first computing device, the instruction to modify the at least one of: the system or the user interface further includes transmitting the instruction to a back end server, wherein transmitting the instruction to the back end server causes the back end server to execute the instruction and modify the at least one of: the system or the user interface.

15. One or more non-transitory computer-readable media storing instructions that, when executed by a computing platform comprising at least one processor, memory, and a communication interface, cause the computing platform to:
receive historical user data from a plurality of data sources, wherein the historical user data is captured via a plurality of computing devices;
train, using the historical user data, a machine learning model to generate recommended modifications of at least one of: a system or a user interface, wherein the recommended modification of the at least one of: the system or the user interface includes modifying at least one of: functionality or a display of the at least one of: the system or the user interface;
receive, from a user and via a first computing device, a user request for event processing;
receive, from at least one data source of the plurality of data sources, user specific data associated with the user;
execute the machine learning model, wherein executing the machine learning model includes using, as inputs, the user specific data, to output a first recommended modification of the at least one of: the system or the user interface;
transmit, to the first computing device, the first recommended modification, wherein transmitting the first recommended modification causes the first computing device to display the first recommended modification of the at least one of: the system or the user interface;
receive, from the first computing device, acceptance of the first recommended modification of the at least one of: the system or the user interface;
generate an instruction to modify the at least one of: the system or the user interface based on the acceptance of the first recommended modification of the at least one of: the system or the user interface;
transmit, to at least the first computing device, the instruction to modify the at least one of: the system or the user interface, wherein transmitting the instruction to modify the at least one of: the system or the user interface causes the first computing device to execute the instruction and modify the at least one of: the system or the user interface; and
update, based on at least the first recommended modification of the at least one of: the system or the user interface, the machine learning model.

16. The one or more non-transitory computer-readable media of claim 15, further including instructions that, when executed, cause the computing platform to:
receive, from the user and via a second computing device, a subsequent request for event processing; and
transmit, to at least the second computing device, the instruction to modify the at least one of: the system or the user interface, wherein transmitting the instruction to modify the at least one of: the system or the user interface causes the second computing device to execute the instruction and modify the at least one of: the system or the user interface.

17. The one or more non-transitory computer-readable media of claim 16, wherein the first computing device is a self-service kiosk of an enterprise organization and the second computing device is a mobile device of the user.

18. The one or more non-transitory computer-readable media of claim 15, further including instructions that, when executed, cause the computing platform to:
receive, from the at least one data source, additional user specific data; and
execute the machine learning model, wherein executing the machine learning model includes using, as inputs, the additional user specific data, to output a second recommended modification of the at least one of: the system or the user interface.

19. The one or more non-transitory computer-readable media of claim 15, wherein the first recommended modification of the at least one of: the system or the user interface includes a modification of at least one of: a font size, a volume of audio output, a number of functions available, and terminology provided to the user.

20. The one or more non-transitory computer-readable media of claim 15, wherein transmitting, to at least the first computing device, the instruction to modify the at least one of: the system or the user interface further includes transmitting the instruction to a back end server, wherein transmitting the instruction to the back end server causes the back end server to execute the instruction and modify the at least one of: the system or the user interface.
